(19) United States
(12) Patent Application Publication
(10) Pub. No.: US 2015/0005468 A1
(43) Pub. Date: Jan. 1, 2015

(54) HIGH PERMEABILITY COPOLYIMIDE GAS SEPARATION MEMBRANES

(71) Applicant: UOP LLC, Des Plaines, IL (US)

(72) Inventors: Zara Osman, Glenview, IL (US); Chunqing Liu, Arlington Heights, IL (US); Angela N. Troxell, Chicago, IL (US); Carl W. Liskey, Chicago, IL (US)

(73) Assignee: UOP LLC, Des Plaines, IL (US)

(21) Appl. No.: 14/277,332

(22) Filed: May 14, 2014

Related U.S. Application Data
(60) Provisional application No. 61/840,492, filed on Jun. 28, 2013.

(51) Int. Cl. B01D 71/64; B01D 61/36; C08G 73/10; B01D 53/22

(52) U.S. Cl. CPC B01D 71/64; B01D 53/228; B01D 61/362; C08G 73/1064
USPC 528/170; 96/14; 95/45; 95/50; 95/53; 95/51; 95/49; 95/47; 95/55; 95/54; 95/52; 210/640; 210/500.33; 528/321

(57) ABSTRACT

The present invention generally relates to high permeability, UV cross-linkable copolyimide polymers and membranes for gas, vapor, and liquid separations, as well as methods for making and using these membranes. The invention provides a process for separating at least one gas from a mixture of gases using the high permeability copolyimide membrane or the UV cross-linked copolyimide membrane, the process comprising: (a) providing a high permeability copolyimide membrane or a UV cross-linked copolyimide membrane which is permeable to said at least one gas; (b) contacting the mixture on one side of the high permeability copolyimide membrane or the UV cross-linked copolyimide membrane to cause said at least one gas to permeate the membrane; and (c) removing from the opposite side of the membrane a permeate gas composition comprising a portion of said at least one gas which permeated said membrane.

### CROSS-REFERENCE TO RELATED APPLICATION

This application claims priority from Provisional Application No. 61/840,492 filed Jun. 28, 2013, the contents of which are hereby incorporated by reference.

### BACKGROUND OF THE INVENTION

This invention relates to new high permeability, UV cross-linkable copolyimide gas separation membranes.

In the past 30-35 years, the state of the art of polymer membrane-based gas separation processes has evolved rapidly. Membrane-based technologies have advantages of both low capital cost and high-energy efficiency compared to conventional separation methods. Membrane gas separation is of special interest to petroleum producers and refiners, chemical companies, and industrial gas suppliers. Several applications of membrane gas separation have achieved commercial success, including nitrogen enrichment from air, carbon dioxide removal from natural gas and from enhanced oil recovery, and also in hydrogen removal from nitrogen, methane, and argon in ammonia purge gas streams. For example, UOP's Separex™ cellulose acetate spiral wound polymeric membrane is currently an international market leader for carbon dioxide removal from natural gas.

Polymers provide a range of properties including low cost, permeability, mechanical stability, and ease of processability that are important for gas separation. Glassy polymers (i.e., polymers at temperatures below their T_{g}) have stiffer polymer backbones and therefore let smaller molecules such as hydrogen and helium pass through more quickly, while larger molecules such as hydrocarbons pass through more slowly as compared to polymers with less stiff backbones. Cellulose acetate (CA) glassy polymer membranes are used extensively in gas separation. Currently, such CA membranes are used for natural gas upgrading, including the removal of carbon dioxide. Although CA membranes have many advantages, they are limited in a number of properties including selectivity, permeability, and in chemical, thermal, and mechanical stability.

The membranes most commonly used in commercial gas and liquid separation applications are asymmetric polymeric membranes and have a thin nonporous selective skin layer that performs the separation. Separation is based on a solution-diffusion mechanism. This mechanism involves molecular-scale interactions of the permeating gas with the membrane polymer. The mechanism assumes that in a membrane having two opposing surfaces, each component is sorbed by the membrane at one surface, transported by a gas concentration gradient, and desorbed at the opposing surface. According to this solution-diffusion model, the membrane performance in separating a given pair of gases (e.g., CO₂/CH₄, O₂/N₂, H₂/CH₄) is determined by two parameters: the permeability coefficient (abbreviated hereinafter as permeability or P_{A}) and the selectivity (α_{A/B}). The P_{A} is the product of the gas flux and the selective skin layer thickness of the membrane, divided by the pressure difference across the membrane. The α_{A/B} is the ratio of the permeability coefficients of the two gases (α_{A/B}=P_{A}/P_{B}) where P_{A} is the permeability of the more permeable gas and P_{B} is the permeability of the less permeable gas. Gases can have high permeability coefficients because of a high solubility coefficient, a high diffusion coefficient, or because both coefficients are high. In general, the diffusion coefficient decreases while the solubility coefficient increases with an increase in the molecular size of the gas. In high performance polymer membranes, both high permeability and selectivity are desirable because higher permeability decreases the size of the membrane area required to treat a given volume of gas, thereby decreasing capital cost of membrane units, and because higher selectivity results in a higher purity product gas.

One of the components to be separated by a membrane must have a sufficiently high permeance at the preferred conditions or extraordinarily large membrane surface areas is required to allow separation of large amounts of material. Permeance, measured in Gas Permeation Units (GPU, 1 GPU=10⁻⁶ cm³ (STP)/cm² s (cm Hg)), is the pressure normalized flux and equals to permeability divided by the skin layer thickness of the membrane. Commercially available gas separation polymer membranes, such as CA, polyimide, and polysulfone membranes formed by phase inversion and solvent exchange methods have an asymmetric integrally skinned membrane structure. Such membranes are characterized by a thin, dense, selectively semipermeable surface “skin” and a less dense void-containing (or porous), non-selective support region, with pore sizes ranging from large in the support region to very small proximate to the “skin”.

US 2006/0011063 disclosed a gas separation membrane formed from polyetherimide by extruding a hollow fiber using a core liquid. For the described membrane, like other asymmetric hollow fiber membranes, one polymer solution is spun from an annular spinneret and the core liquid is pumped into the center of the annulus.

US 2009/0297850 A1 disclosed a hollow fiber membrane derived from polyimide membrane, and the polyimide includes a repeating unit obtained from aromatic diamine including at least one ortho-positioned functional group with respect to an amine group and dianhydride.

U.S. Pat. No. 7,422,623 reported the preparation of polyimide hollow fiber membranes using annealed polyimide polymers, particularly polyimide polymers with low molecular weight sold under the trade name P-84. The polyimide polymers are annealed at high temperature from 140° to 180° C. for about 6 to 10 hours to improve the mechanical properties of the polymers. The resulting membranes prepared from the high temperature annealed polyimides are suitable for high pressure applications. This polymer annealing method, however, is not suitable for high molecular weight, easily thermally cross-linkable, or easily thermally decomposed polymer membrane materials.

U.S. Pat. No. 8,366,804 disclosed a new type of polyimide hollow fiber membranes for air separation. The polyimide disclosed in U.S. Pat. No. 8,366,804 was prepared from polycondensation reaction of 3,3′,5,5′-tetramethyl-4,4′-methylene dianiline (TMMDA) with high cost 3,3′,4,4′-diphenylsulfone tetracarboxylic dianhydride (DSDA) and 3,3′,4,4′-diphenylsulfone tetracarboxylic dianhydride (BTDA).

US 2005/0268783 A1, US 2009/0182097 A1, and US 2009/0178561 A1 disclosed chemically cross-linked polyimide hollow fiber membranes prepared from two separate steps. Step one is the synthesis of a monoesterified polyimide polymer in a solution by treating a polyimide polymer containing carboxylic acid functional group with a small diol molecule at esterification conditions in the presence of dehydrating conditions. However, significant extra amount of diol was used to prevent the formation of biesterified polyimide polymer. Step two is the solid state transesterification of the monoesterified polyimide membrane at elevated temperature to form a cross-linked polyimide membrane.

Chemical cross-linking of polyimides using diamine small molecules was also disclosed. (J. MEMBR. SCI, 2001, 189, 231-239) However, CO₂ permeability decreased significantly after this type of cross-linking. In addition, the thermal stability and hydrolytic stability of the diamine cross-linked polyimide were not improved.

Koros et al. disclosed decarboxylation-induced thermally cross-linked polyimide membrane. (J. MEMBR. SCI, 2011, 382, 212-221) However, decarboxylation reaction among the carboxylic acid groups on the carboxylic acid group-containing polyimide membrane occurred at temperatures higher than the glass transition temperature of the polyimide polymer. Such a high temperature resulted in densification of the substructure of the membrane and decreased membrane permeance.

U.S. Pat. No. 7,485,173 disclosed UV cross-linked mixed matrix membranes via UV radiation. The cross-linked mixed matrix membranes comprise microporous materials dispersed in the continuous UV cross-linked polymer matrix.

The present invention discloses a new type of high permeability, UV cross-linkable copolyimide gas separation membranes and methods for making and using these membranes.

### SUMMARY OF THE INVENTION

The invention relates to a UV cross-linkable copolyimide polymer comprising a plurality of repeating units of formula (I):

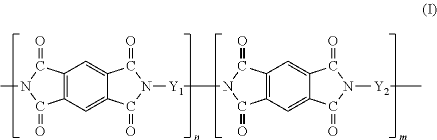

wherein Y1 is selected from the group consisting of

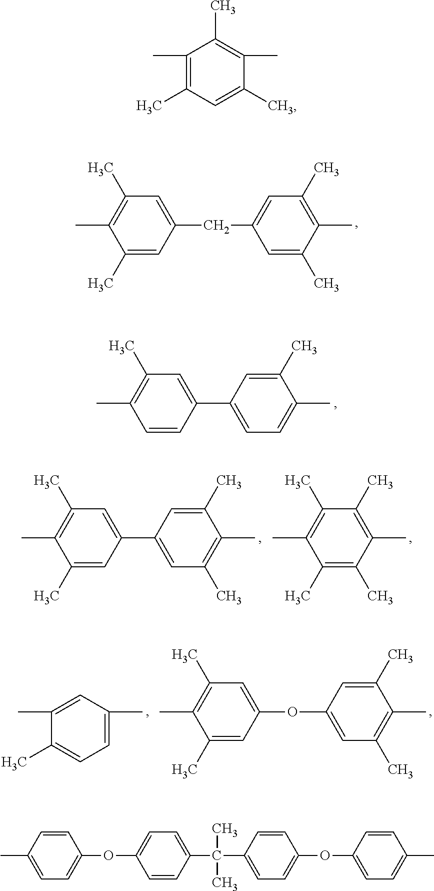

and mixtures thereof, and wherein Y2 is selected from the group consisting of

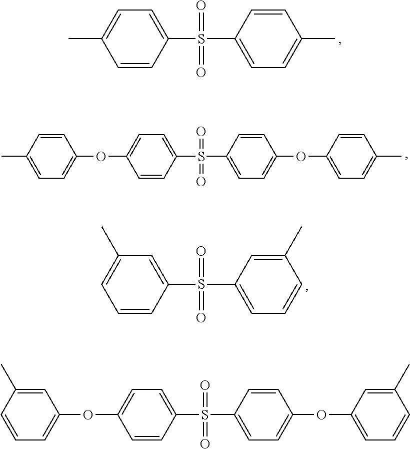

and mixtures thereof; wherein n and m are independent integers from 2 to 500. This UV cross-linkable copolyimide polymer may be exposed to UV radiation to be cross-linked to form a UV cross-linked copolyimide polymer. The UV cross-linkable copolyimide polymer may be formed into a membrane.

The UV cross-linkable copolyimide polymer of the invention may be selected from the group consisting of a poly(pyromellitic dianhydride-2,4,6-trimethyl-m-phenylenediamine-3,3′-diaminodiphenyl sulfone) polyimide derived from the polycondensation reaction of pyromellitic dianhydride with a mixture of 2,4,6-trimethyl-m-phenylenediamine and 3,3′-diaminodiphenyl sulfone; a poly(pyromellitic dianhydride-3,3′,5,5′-tetramethyl-4,4′-methylene dianiline-3,3′-diaminodiphenyl sulfone) polyimide derived from the polycondensation reaction of pyromellitic dianhydride with a mixture of 3,3′,5,5′-tetramethyl-4,4′-methylene dianiline and 3,3′-diaminodiphenyl sulfone; poly(pyromellitic dianhydride-2,4,6-trimethyl-m-phenylenediamine-4,4′-diaminodiphenyl sulfone) polyimide derived from the polycondensation reaction of pyromellitic dianhydride with a mixture of 2,4,6-trimethyl-m-phenylenediamine and 4,4′-diaminodiphenyl sulfone (4,4′-diaminodiphenyl sulfone); poly(pyromellitic dianhydride-3,3′,5,5′-tetramethyl-4,4′-methylene dianiline-4,4′-diaminodiphenyl sulfone) polyimide derived from the polycondensation reaction of pyromellitic dianhydride with a mixture of 3,3′,5,5′-tetramethyl-4,4′-methylene dianiline and 4,4′-diaminodiphenyl sulfone.

The invention also involves a process for separating at least one gas from a mixture of gases comprising: a. providing a UV cross-linkable copolyimide polymer membrane comprising a UV cross-linkable copolyimide polymer comprising a plurality of repeating units of formula (I):

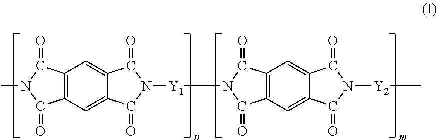

wherein Y1 is selected from the group consisting of

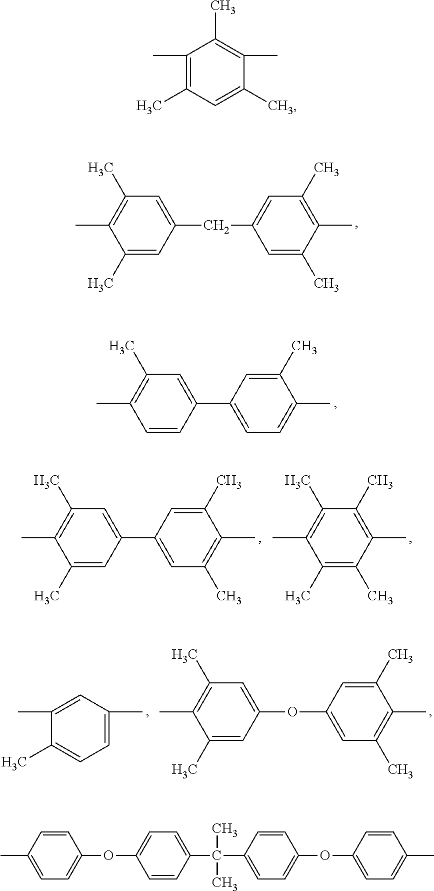

and mixtures thereof, and wherein Y2 is selected from the group consisting of

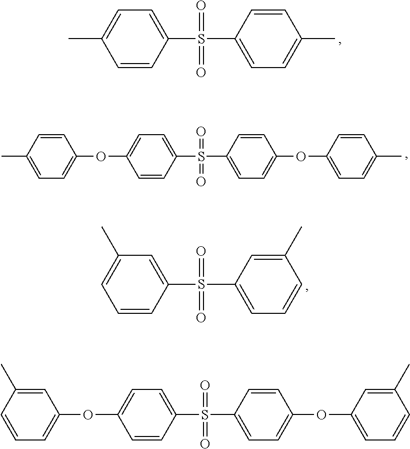

and mixtures thereof; wherein n and m are independent integers from 2 to 500; contacting the mixture of gases to one side of said UV cross-linkable copolyimide polymer membrane to cause at least one gas to permeate said membrane; and removing from an opposite side of said UV cross-linkable copolyimide polymer membranea permeate gas composition comprising a portion of said at least one gas that permeated said membrane. The at least two gases may be a mixture of volatile organic compounds and atmospheric gas. The at least two gases may be a mixture of helium, carbon dioxide or hydrogen sulfide, or mixtures thereof in a natural gas stream.

The mixture of gases that are separated may be a pair of gases selected from the group consisting of nitrogen and oxygen, carbon dioxide and methane, hydrogen and methane or a mixture of carbon monoxide, helium and methane. The mixture of gases may be selected from the group consisting of a mixture of iso and normal paraffins, and a mixture of xylenes. The mixture of gases may be a hydrocarbon vapor and hydrogen. The mixture of gases may comprise a mixture of two or more gases selected from methane, carbon dioxide, oxygen, nitrogen, water vapor, hydrogen sulfide, and helium.

The invention further comprises a pervaporation process for separating at least one liquid from a mixture of liquids comprising: providing a UV cross-linkable copolyimide polymer membrane comprising a UV cross-linkable copolyimide polymer comprising a plurality of repeating units of formula (I):

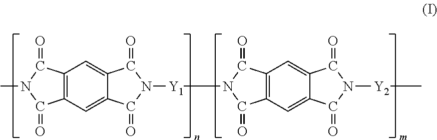

wherein Y1 is selected from the group consisting of

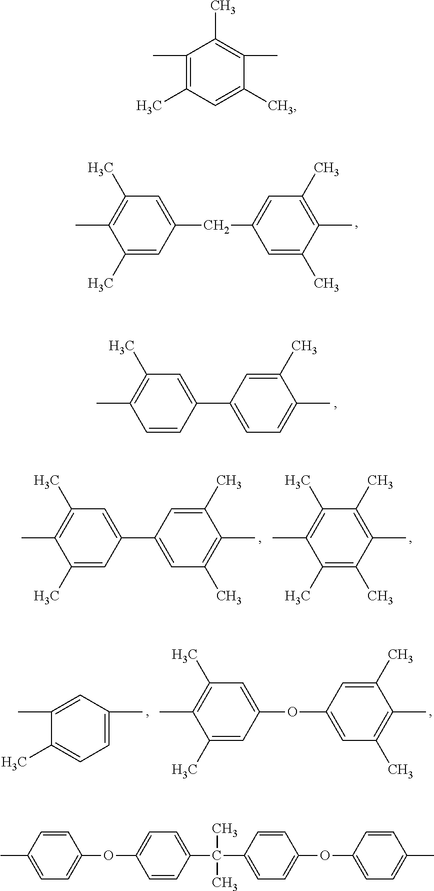

and mixtures thereof, and wherein Y2 is selected from the group consisting of

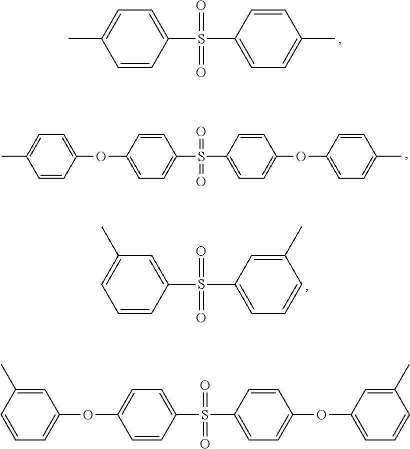

and mixtures thereof; wherein n and m are independent integers from 2 to 500; contacting the mixture of liquids to one side of the UV cross-linkable copolyimide polymer membrane to cause at least one vapor phase to permeate the membrane; and removing from an opposite side of the UV cross-linkable copolyimide polymer membrane a permeate gas composition comprising a portion of the at least one vapor phase that permeated the membrane.

The liquid mixture may comprise one or more organic compounds selected from the group consisting of alcohols, phenols, chlorinated hydrocarbons, pyridines, and ketones in water. The liquid mixture may comprise a naphtha hydrocarbon stream comprising sulfur-containing compounds. The liquid mixture may comprise a mixture of organic compounds selected from the group consisting of ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.

### DESCRIPTION OF THE INVENTION

The present invention generally relates to high permeability, UV cross-linkable copolyimide polymers and membranes for gas, vapor, and liquid separations, as well as methods for making and using these membranes.

The present invention provides a high permeability, UV cross-linkable copolyimide membrane. The copolyimide polymer used for the preparation of the high permeability, UV cross-linkable copolyimide membrane in the present invention is a poly(pyromellitic dianhydride-3,3′,5,5′-tetramethyl-4,4′-methylene dianiline-3,3′-diaminodiphenyl sulfone) derived from the polycondensation reaction of pyromellitic dianhydride (PMDA) with 3,3′,5,5′-tetramethyl-4,4′-methylene dianiline (TMMDA) and 3,3′-diaminodiphenyl sulfone (3,3′-DDS). The molar ratio of TMMDA to 3,3′-DDS can be in a range from 10:1 to 1:10. The polyimide membrane described in the present invention is fabricated from the corresponding polyimide described herein. A copolyimide membrane prepared from poly(pyromellitic dianhydride-3,3′,5,5′-tetramethyl-4,4′-methylene dianiline-3,3′-diaminodiphenyl sulfone) with a 3:1 molar ratio of TMMDA to 3,3′-DDS (abbreviated as poly(PMDA-TMMDA-DDS-3-1)) showed a high CO₂ permeability of 92.2 and an intrinsic CO₂/CH₄ selectivity of 17.2 for CO₂/CH₄ separation. The UV cross-linked poly(PMDA-TMMDA-DDS-3-1) membrane showed a high intrinsic CO₂/CH₄ selectivity of 62.6 and a CO₂ permeability of 17.7 Barrers for CO₂/CH₄ separation. The UV cross-linked poly(PMDA-TMMDA-DDS-3-1) membrane also showed a high intrinsic H₂/CH₄ selectivity of 409 and a H₂ permeability of 115.7 Barrers for H₂/CH₄ separation. In addition, the UV cross-linked poly(PMDA-TMMDA-DDS-3-1) membrane also showed a high intrinsic He/CH₄ selectivity of 326.2 and a He permeability of 92.3 Barrers for He/CH₄ separation.

The high permeability, UV cross-linkable copolyimide polymers and membranes described in the present invention comprises a plurality of repeating units of formula (I).

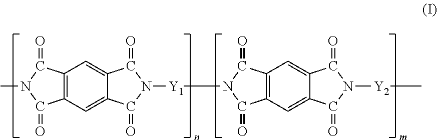

wherein Y1 is selected from the group consisting of

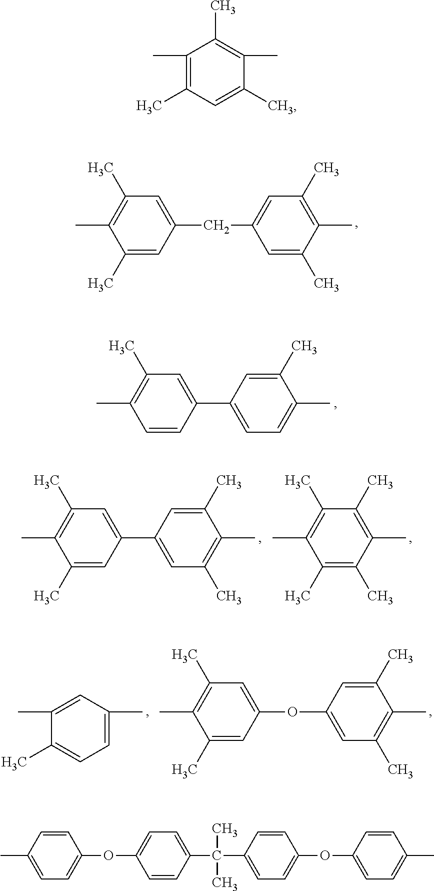

and mixtures thereof, and wherein Y2 is selected from the group consisting of

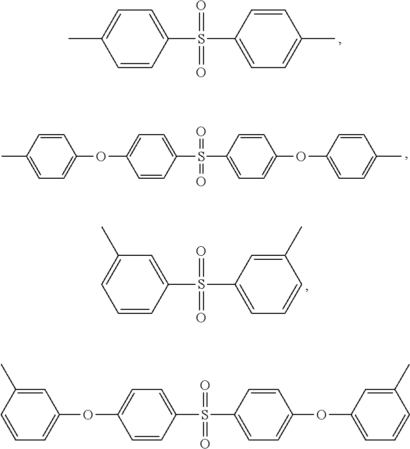

and mixtures thereof; wherein n and m are independent integers from 2 to 500; wherein n/m is in a range of 10:1 to 1:10.

In another embodiment of the invention, this invention pertains to copolyimide membranes that have undergone an additional UV cross-linking step via exposure of the copolyimide membrane to UV radiation. The sulfonic (—SO₂—) groups and the methyl (—CH₃) groups on different main polymer chains of the copolyimide polymers described in the current invention react with each other under UV radiation to form covalent bonds. Therefore, the cross-linked copolyimide membranes comprise polymer chain segments cross-linked to each other through covalent bonds. The cross-linked copolyimide membranes showed significantly improved selectivities compared to the copolyimide membranes without cross-linking.

The copolyimide polymers shown in formula (I) used for making the high permeability copolyimide membranes in the current invention have a weight average molecular weight in the range of 20,000 to 1,000,000 g/mol, preferably between 50,000 to 500,000 g/mol.

Some examples of the copolyimide polymer described in the current invention may include, but are not limited to: poly(pyromellitic dianhydride-2,4,6-trimethyl-m-phenylenediamine-3,3′-diaminodiphenyl sulfone) polyimide derived from the polycondensation reaction of pyromellitic dianhydride (PMDA) with a mixture of 2,4,6-trimethyl-m-phenylenediamine (TMPDA) and 3,3′-diaminodiphenyl sulfone (3,3′-DDS); poly(PMDA-3,3′,5,5′-tetramethyl-4,4′-methylene dianiline-DDS) polyimide derived from the polycondensation reaction of PMDA with a mixture of 3,3′,5,5′-tetramethyl-4,4′-methylene dianiline (TMMDA) and 3,3′-DDS; poly(PMDA-TMPDA-4,4′-diaminodiphenyl sulfone) polyimide derived from the polycondensation reaction of PMDA with a mixture of TMPDA and 4,4′-diaminodiphenyl sulfone (4,4′-DDS); poly(PMDA-TMMDA-4,4′-DDS) polyimide derived from the polycondensation reaction of PMDA with a mixture of TMMDA and 4,4′-DDS.

The high permeability copolyimide membrane described in the present invention can be fabricated into any convenient geometry such as flat sheet (or spiral wound), tube, or hollow fiber.

The invention provides a process for separating at least one gas from a mixture of gases using the high permeability copolyimide membrane or the UV cross-linked copolyimide membrane described in the present invention, the process comprising: (a) providing a high permeability copolyimide membrane or a UV cross-linked copolyimide membrane described in the present invention which is permeable to said at least one gas; (b) contacting the mixture on one side of the high permeability copolyimide membrane or the UV cross-linked copolyimide membrane described in the present invention to cause said at least one gas to permeate the membrane; and (c) removing from the opposite side of the membrane a permeate gas composition comprising a portion of said at least one gas which permeated said membrane.

The high permeability copolyimide membrane or the UV cross-linked copolyimide membrane described in the present invention is especially useful in the purification, separation or adsorption of a particular species in the liquid or gas phase. In addition to separation of pairs of gases, the high permeability copolyimide membrane or the UV cross-linked copolyimide membrane described in the present invention may, for example, be used for the desalination of water by reverse osmosis or for the separation of proteins or other thermally unstable compounds, e.g. in the pharmaceutical and biotechnology industries. The high permeability copolyimide membrane or the UV cross-linked copolyimide membrane described in the present invention may also be used in fermenters and bioreactors to transport gases into the reaction vessel and transfer cell culture medium out of the vessel. Additionally, the high permeability copolyimide membrane or the UV cross-linked copolyimide membrane described in the present invention may be used for the removal of microorganisms from air or water streams, water purification, ethanol production in a continuous fermentation/membrane pervaporation system, and in detection or removal of trace compounds or metal salts in air or water streams.

The high permeability copolyimide membrane or the UV cross-linked copolyimide membrane described in the present invention is especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of He, CO₂ or H₂S from natural gas, H₂ from N₂, CH₄, and Ar in ammonia purge gas streams, H₂ recovery in refineries, xylene separations, iso/normal paraffin separations, liquid natural gas separations, C2+ hydrocarbon recovery. Any given pair or group of gases that differ in molecular size, for example nitrogen and oxygen, carbon dioxide and methane, hydrogen and methane or carbon monoxide, helium and methane, can be separated using the high permeability copolyimide membrane or the UV cross-linked copolyimide membrane described in the present invention. More than two gases can be removed from a third gas. For example, some of the gas components which can be selectively removed from a raw natural gas using the high permeability copolyimide membrane or the UV cross-linked copolyimide membrane described herein include carbon dioxide, oxygen, nitrogen, water vapor, hydrogen sulfide, helium, and other trace gases. Some of the gas components that can be selectively retained include hydrocarbon gases. When permeable components are acid components selected from the group consisting of carbon dioxide, hydrogen sulfide, and mixtures thereof and are removed from a hydrocarbon mixture such as natural gas, one module, or at least two in parallel service, or a series of modules may be utilized to remove the acid components. For example, when one module is utilized, the pressure of the feed gas may vary from 275 kPa to about 2.6 MPa (25 to 4000 psi). The differential pressure across the membrane can be as low as about 70 kPa or as high as 14.5 MPa (about 10 psi or as high as about 2100 psi) depending on many factors such as the particular membrane used, the flow rate of the inlet stream and the availability of a compressor to compress the permeate stream if such compression is desired. Differential pressure greater than about 14.5 MPa (2100 psi) may rupture the membrane. A differential pressure of at least 0.7 MPa (100 psi) is preferred since lower differential pressures may require more modules, more time and compression of intermediate product streams. The operating temperature of the process may vary depending upon the temperature of the feed stream and upon ambient temperature conditions. Preferably, the effective operating temperature of the membranes of the present invention will range from about −50° to about 150° C. More preferably, the effective operating temperature of the high permeability copolyimide membrane or the UV cross-linked copolyimide membrane of the present invention will range from about −20° to about 100° C., and most preferably, the effective operating temperature of the membranes of the present invention will range from about 25° to about 100° C.

The high permeability copolyimide membrane or the UV cross-linked copolyimide membrane described in the present invention are also especially useful in gas/vapor separation processes in chemical, petrochemical, pharmaceutical and allied industries for removing organic vapors from gas streams, e.g. in off-gas treatment for recovery of volatile organic compounds to meet clean air regulations, or within process streams in production plants so that valuable compounds (e.g., vinylchloride monomer, propylene) may be recovered. Further examples of gas/vapor separation processes in which the high permeability copolyimide membrane or the UV cross-linked copolyimide membrane described in the present invention may be used are hydrocarbon vapor separation from hydrogen in oil and gas refineries, for hydrocarbon dew pointing of natural gas (i.e. to decrease the hydrocarbon dew point to below the lowest possible export pipeline temperature so that liquid hydrocarbons do not separate in the pipeline), for control of methane number in fuel gas for gas engines and gas turbines, and for gasoline recovery. The high permeability copolyimide membrane or the UV cross-linked copolyimide membrane described in the present invention may incorporate a species that adsorbs strongly to certain gases (e.g. cobalt porphyrins or phthalocyanines for O₂ or silver (I) for ethane) to facilitate their transport across the membrane.

The high permeability copolyimide membrane or the UV cross-linked copolyimide membrane described in the present invention can also be operated at high temperature to provide the sufficient dew point margin for natural gas upgrading (e.g., CO₂ removal from natural gas). The high permeability copolyimide membrane or the UV cross-linked copolyimide membrane described in the present invention can be used in either a single stage membrane or as the first or/and second stage membrane in a two stage membrane system for natural gas upgrading.

The high permeability copolyimide membrane or the UV cross-linked copolyimide membrane described in the present invention may also be used in the separation of liquid mixtures by pervaporation, such as in the removal of organic compounds (e.g., alcohols, phenols, chlorinated hydrocarbons, pyridines, ketones) from water such as aqueous effluents or process fluids. The term ‘pervaporation’ is derived from the two steps of the process: first permeation through the membrane by the permeate, then its evaporation into the vapor phase. This process is used by a number of industries for several different processes, including purification and analysis, due to its simplicity and in-line nature. The membrane acts as a selective barrier between the two phases: the liquid-phase feed and the vapor-phase permeate. It allows the desired component(s) of the liquid feed to transfer through it by vaporization. Separation of components is based on a difference in transport rate of individual components through the membrane. Typically, the upstream side of the membrane is at ambient pressure and the downstream side is under vacuum to allow the evaporation of the selective component after permeation through the membrane. Driving force for the separation is the difference in the partial pressures of the components on the two sides and not the volatility difference of the components in the feed. The driving force for transport of different components is provided by a chemical potential difference between the liquid feed/retentate and vapor permeate at each side of the membrane. The retentate is the remainder of the feed leaving the membrane feed chamber, which is not permeated through the membrane. The chemical potential can be expressed in terms of fugacity, given by Raoult's law for a liquid and by Dalton's law for (an ideal) gas. During operation, due to removal of the vapor-phase permeate, the actual fugacity of the vapor is lower than anticipated on basis of the collected (condensed) permeate.

Separation of components (e.g. water and ethanol) is based on a difference in transport rate of individual components through the membrane. This transport mechanism can be described using the solution-diffusion model, based on the rate/degree of dissolution of a component into the membrane and its velocity of transport (expressed in terms of diffusivity) through the membrane, which will be different for each component and membrane type leading to separation.

A membrane which is ethanol-selective would be used to increase the ethanol concentration in relatively dilute ethanol solutions (5-10% ethanol) obtained by fermentation processes. Another liquid phase separation example using the high permeability copolyimide membrane or the UV cross-linked copolyimide membrane described in the present invention is the deep desulfurization of gasoline and diesel fuels by a pervaporation membrane process similar to the process described in U.S. Pat. No. 7,048,846, incorporated by reference herein in its entirety. The high permeability copolyimide membrane or the UV cross-linked copolyimide membrane described in the present invention that are selective to sulfur-containing molecules would be used to selectively remove sulfur-containing molecules from fluid catalytic cracking (FCC) and other naphtha hydrocarbon streams. Further liquid phase examples include the separation of one organic component from another organic component, e.g. to separate isomers of organic compounds. Mixtures of organic compounds which may be separated using the high permeability copolyimide membrane or the UV cross-linked copolyimide membrane described in the present invention include: ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.

The following example is provided to illustrate one or more preferred embodiments of the invention, but is not limited to embodiments thereof. Numerous variations can be made to the following example that lies within the scope of the invention.

### EXAMPLE

### Preparation and Evaluation of High Permeability Copolyimide Dense Film Membrane from poly(PMDA-TMMDA-DDS-3-1) Copolyimide

10.0 g of poly(PMDA-TMMDA-DDS-3-1) polyimide synthesized from polycondensation reaction of PMDA dianhydride with a mixture of TMMDA and 3,3′-DDS (TMMDA/3,3′-DDS=3:1 molar ratio) was dissolved in 40.0 g of NMP. The mixture was mechanically stirred for 2 hours to form a homogeneous casting dope. The resulting homogeneous casting dope was allowed to degas overnight. The poly(PMDA-TMMDA-DDS-3-1) membrane was prepared from the bubble free casting dope on a clean glass plate using a doctor knife with a 18-mil gap. The membrane together with the glass plate was then put into a vacuum oven. The solvents were removed by slowly increasing the vacuum and the temperature of the vacuum oven. Finally, the poly(PMDA-TMMDA-DDS-3-1) dense film membrane was heated at 200° C. under vacuum for 48 hours to completely remove the residual solvents. The poly(PMDA-TMMDA-DDS-3-1) polyimide dense film membrane was exposed to UV radiation to form a UV cross-linked poly(PMDA-TMMDA-DDS-3-1) polyimide dense film membrane.

The poly(PMDA-TMMDA-DDS-3-1) copolyimide dense film membrane and the UV cross-linked poly(PMDA-TMMDA-DDS-3-1) copolyimide dense film membrane are useful for a variety of gas separation applications such as CO₂/CH₄, H₂/CH₄, and He/CH₄ separations. The dense film membranes were tested for CO₂/CH₄, H₂/CH₄, and He/CH₄ separations at 50° C. under 791 kPa (100 psig) pure single feed gas pressure. The results in Table 1 show that poly(PMDA-TMMDA-DDS-3-1) copolyimide dense film membrane has a high CO₂ permeability of 92.2 Barrers and CO₂/CH₄ selectivity of 17.2 for CO₂/CH₄ separation. The UV cross-linked poly(PMDA-TMMDA-DDS-3-1) copolyimide dense film membrane has a high intrinsic CO₂/CH₄ selectivity of 62.6 and a CO₂ permeability of 17.7 Barrers for CO₂/CH₄ separation. The UV cross-linked poly(PMDA-TMMDA-DDS-3-1) dense film membrane also has a high intrinsic H₂/CH₄ selectivity of 409 and a H₂ permeability of 115.7 Barrers for H₂/CH₄ separation (Table 2). In addition, the UV cross-linked poly(PMDA-TMMDA-DDS-3-1) dense film membrane has a high intrinsic He/CH₄ selectivity of 326.2 and a He permeability of 92.3 Barrers for He/CH₄ separation (Table 3).

TABLE 1
Pure Gas Permeation Test Results of poly(PMDA-TMMDA-DDS-3-1)
copolyimide dense film membrane and the UV cross-linked
poly(PMDA-TMMDA-DDS-3-1)copolyimide dense film membrane
for CO₂/CH₄ Separation*

| Membrane | P_{CO2} (Barrer) | α_{CO2/CH4} |
|---|---|---|
| Poly(PMDA-TMMDA-DDS-3-1) | 92.2 | 17.2 |
| UV cross-linked poly(PMDA-TMMDA-DDS- | 17.7 | 62.6 |
| 3-1) | | |

*P_{CO2} and P_{CH4} were tested at 50° C. and 791 kPa (100 psig);
1 Barrer = 10⁻¹⁰ cm³(STP) · cm/cm² · sec · cmHg.

TABLE 2
Pure Gas Permeation Test Results of poly(PMDA-TMMDA-DDS-3-1)
copolyimide dense film membrane and the UV cross-linked
poly(PMDA-TMMDA-DDS-3-1)copolyimide dense film membrane
for H₂/CH₄ Separation*

| Membrane | P_{H2} (Barrer) | α_{H2/CH4} |
|---|---|---|
| Poly(PMDA-TMMDA-DDS-3-1) | 139.9 | 26.2 |
| UV cross-linked poly(PMDA-TMMDA-DDS- | 115.7 | 409.0 |
| 3-1) | | |

*P_{H2} and P_{CH4} were tested at 50° C. and 791 kPa (100 psig);
1 Barrer = 10⁻¹⁰ cm³(STP) · cm/cm² · sec · cmHg.

TABLE 3
Pure Gas Permeation Test Results of poly(PMDA-TMMDA-DDS-3-1)
copolyimide dense film membrane and the UV cross-linked
poly(PMDA-TMMDA-DDS-3-1)copolyimide dense film membrane
for He/CH₄ Separation*

| Membrane | P_{He} (Barrer) | α_{He/CH4} |
|---|---|---|
| Poly(PMDA-TMMDA-DDS-3-1) | 97.6 | 18.2 |
| UV cross-linked poly(PMDA-TMMDA-DDS- | 92.3 | 326.2 |
| 3-1) | | |

*P_{He} and P_{CH4} were tested at 50° C. and 791 kPa (100 psig);
1 Barrer = 10⁻¹⁰ cm³(STP) · cm/cm² · sec · cmHg.

### SPECIFIC EMBODIMENTS

While the following is described in conjunction with specific embodiments, it will be understood that this description is intended to illustrate and not limit the scope of the preceding description and the appended claims.

A first embodiment of the invention is a UV cross-linkable copolyimide polymer comprising a plurality of repeating units of formula (I)

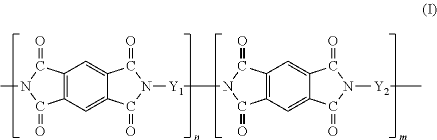

wherein Y1 is selected from the group consisting of

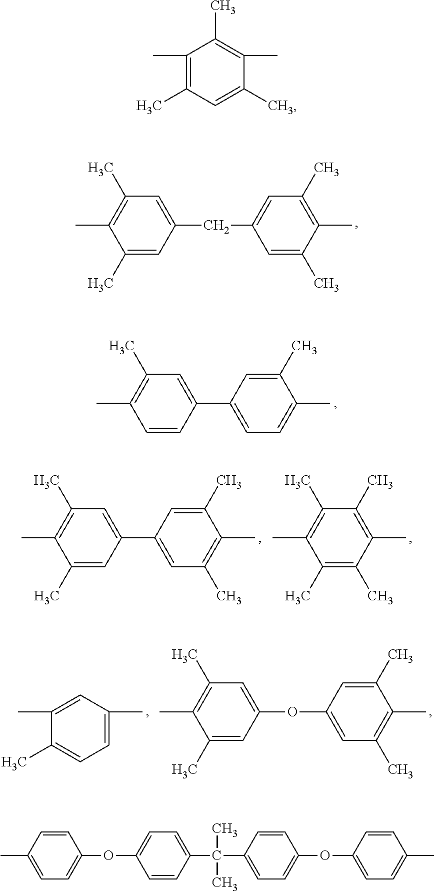

and mixtures thereof, and wherein Y2 is selected from the group consisting of

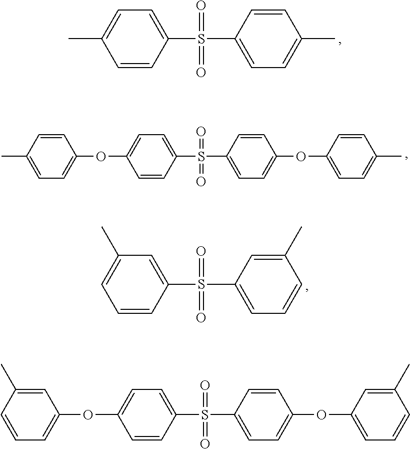

and mixtures thereof; wherein n and m are independent integers from 2 to 500. An embodiment of the invention is one, any or all of prior embodiments in this paragraph up through the first embodiment in this paragraph wherein the UV cross-linkable copolyimide polymer of has been exposed to UV radiation to be cross-linked to form a UV cross-linked copolyimide polymer. An embodiment of the invention is one, any or all of prior embodiments in this paragraph up through the first embodiment in this paragraph wherein the UV cross-linkable copolyimide polymer is selected from the group consisting of a poly(pyromellitic dianhydride-2,4,6-trimethyl-m-phenylenediamine-3,3′-diaminodiphenyl sulfone) polyimide derived from the polycondensation reaction of pyromellitic dianhydride with a mixture of 2,4,6-trimethyl-m-phenylenediamine and 3,3′-diaminodiphenyl sulfone; a poly(pyromellitic dianhydride-3,3′,5,5′-tetramethyl-4,4′-methylene dianiline-3,3′-diaminodiphenyl sulfone) polyimide derived from the polycondensation reaction of pyromellitic dianhydride with a mixture of 3,3′,5,5′-tetramethyl-4,4′-methylene dianiline and 3,3′-diaminodiphenyl sulfone; poly(pyromellitic dianhydride-2,4,6-trimethyl-m-phenylenediamine-4,4′-diaminodiphenyl sulfone) polyimide derived from the polycondensation reaction of pyromellitic dianhydride with a mixture of 2,4,6-trimethyl-m-phenylenediamine and 4,4′-diaminodiphenyl sulfone; poly(pyromellitic dianhydride-3,3′,5,5′-tetramethyl-4,4′-methylene dianiline-4,4′-diaminodiphenyl sulfone) polyimide derived from the polycondensation reaction of pyromellitic dianhydride with a mixture of 3,3′,5,5′-tetramethyl-4,4′-methylene dianiline and 4,4′-diaminodiphenyl sulfone. An embodiment of the invention is one, any or all of prior embodiments in this paragraph up through the UV cross-linkable copolyimide polymer is formed into a membrane. An embodiment of the invention is one, any or all of prior embodiments in this paragraph up through the first embodiment in this paragraph wherein the UV cross-linkable copolyimide polymer further comprises a species that adsorbs strongly to a gas.

A second embodiment of the invention is a process for separating at least one gas from a mixture of gases comprising (a) providing a UV cross-linkable copolyimide polymer membrane comprising a UV cross-linkable copolyimide polymer comprising a plurality of repeating units of formula (I)

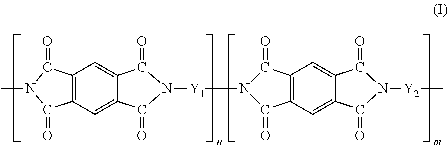

wherein Y1 is selected from the group consisting of

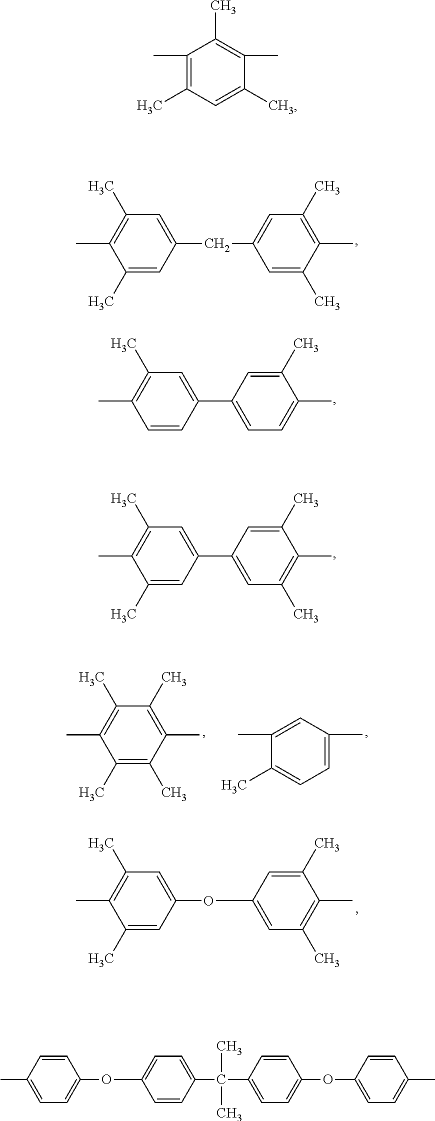

and mixtures thereof, and wherein Y2 is selected from the group consisting of

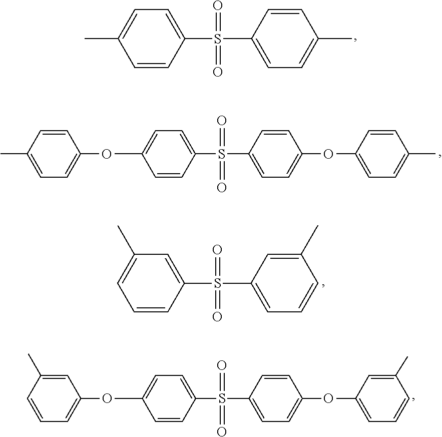

and mixtures thereof; wherein n and m are independent integers from 2 to 500; (b) contacting the mixture of gases to one side of the UV cross-linkable copolyimide polymer membrane to cause at least one gas to permeate the membrane; and (c) removing from an opposite side of the UV cross-linkable copolyimide polymer membrane a permeate gas composition comprising a portion of the at least one gas that permeated the membrane. An embodiment of the invention is one, any or all of prior embodiments in this paragraph up through the second embodiment in this paragraph wherein the at least two gases are a mixture of volatile organic compounds and atmospheric gas. An embodiment of the invention is one, any or all of prior embodiments in this paragraph up through the second embodiment in this paragraph wherein the at least two gases are a mixture of helium, carbon dioxide or hydrogen sulfide, or mixtures thereof in a natural gas stream. An embodiment of the invention is one, any or all of prior embodiments in this paragraph up through the second embodiment in this paragraph wherein the mixture of gases are a pair of gases selected from the group consisting of nitrogen and oxygen, carbon dioxide and methane, hydrogen and methane or a mixture of carbon monoxide, helium and methane. An embodiment of the invention is one, any or all of prior embodiments in this paragraph up through the second embodiment in this paragraph wherein the mixture of gases are selected from the group consisting of a mixture of iso and normal paraffins, and a mixture of xylenes. An embodiment of the invention is one, any or all of prior embodiments in this paragraph up through the second embodiment in this paragraph wherein the mixture of gases are a hydrocarbon vapor and hydrogen. An embodiment of the invention is one, any or all of prior embodiments in this paragraph up through the second embodiment in this paragraph wherein the mixture of gases comprises methane, carbon dioxide, oxygen, nitrogen, water vapor, hydrogen sulfide, and helium. An embodiment of the invention is one, any or all of prior embodiments in this paragraph up through the second embodiment in this paragraph wherein the UV cross-linkable copolyimide polymer membrane is exposed to UV radiation to form a UV cross-linked copolyimide polymer membrane.

A third embodiment of the invention is a a pervaporation process for separating at least one liquid from a mixture of liquids comprising (a) providing a UV cross-linkable copolyimide polymer membrane comprising a UV cross-linkable copolyimide polymer comprising a plurality of repeating units of formula (I)

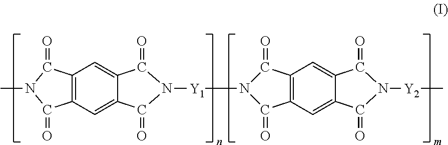

wherein Y1 is selected from the group consisting of

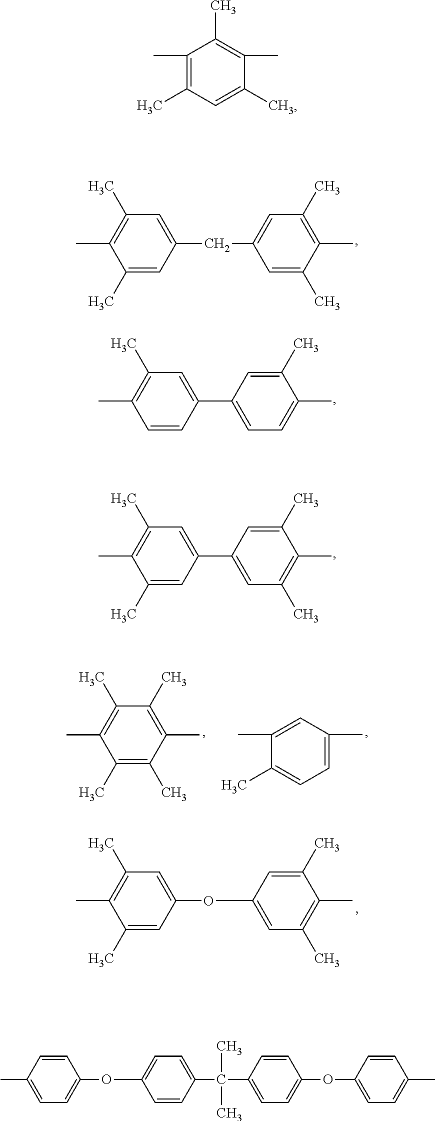

and mixtures thereof, and wherein Y2 is selected from the group consisting of

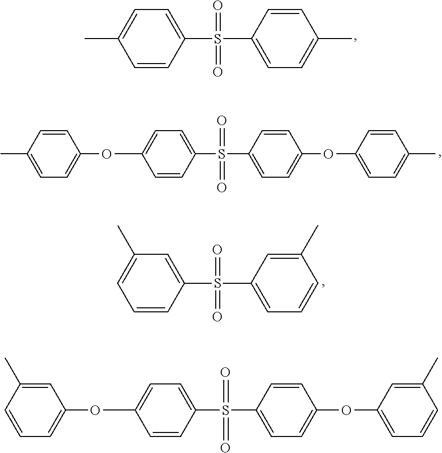

and mixtures thereof; wherein n and m are independent integers from 2 to 500; (b) contacting the mixture of liquids to one side of the UV cross-linkable copolyimide polymer membrane to cause at least one vapor phase to permeate the membrane; and (c) removing from an opposite side of the UV cross-linkable copolyimide polymer membranea permeate a gas composition comprising a portion of the at least one vapor phase that permeated the membrane. An embodiment of the invention is one, any or all of prior embodiments in this paragraph up through the third embodiment in this paragraph wherein the liquid mixture comprises one or more organic compounds selected from the group consisting of alcohols, phenols, chlorinated hydrocarbons, pyridines, and ketones in water. An embodiment of the invention is one, any or all of prior embodiments in this paragraph up through the third embodiment in this paragraph wherein the liquid mixture comprises a naphtha hydrocarbon stream comprising sulfur-containing compounds. An embodiment of the invention is one, any or all of prior embodiments in this paragraph up through the third embodiment in this paragraph wherein the liquid mixture comprises a mixture of organic compounds selected from the group consisting of ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A UV cross-linkable copolyimide polymer comprising a plurality of repeating units of formula (I): 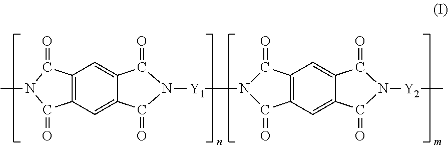
wherein Y1 is selected from the group consisting of 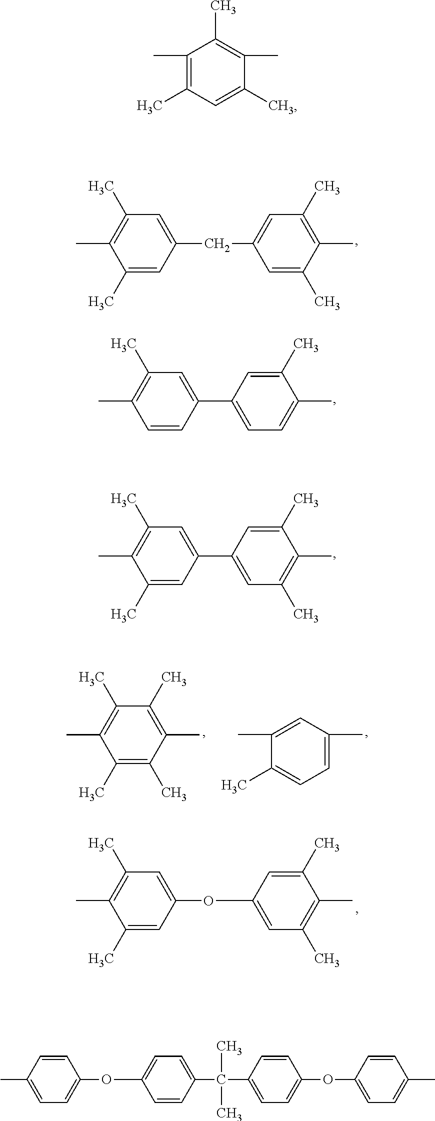
and mixtures thereof, and wherein Y2 is selected from the group consisting of 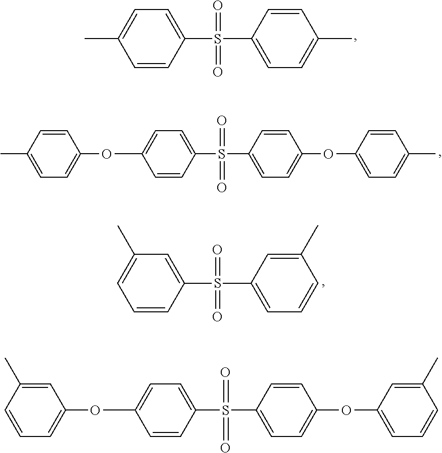
and mixtures thereof; wherein n and m are independent integers from 2 to 500.

2. The UV cross-linkable copolyimide polymer of claim 1 that has been exposed to UV radiation to be cross-linked to form a UV cross-linked copolyimide polymer.

3. The UV cross-linkable copolyimide polymer of claim 1 wherein said UV cross-linkable copolyimide polymer is selected from the group consisting of a poly(pyromellitic dianhydride-2,4,6-trimethyl-m-phenylenediamine-3,3′-diaminodiphenyl sulfone) polyimide derived from the polycondensation reaction of pyromellitic dianhydride with a mixture of 2,4,6-trimethyl-m-phenylenediamine and 3,3′-diaminodiphenyl sulfone; a poly(pyromellitic dianhydride-3,3′,5,5′-tetramethyl-4,4′-methylene dianiline-3,3′-diaminodiphenyl sulfone) polyimide derived from the polycondensation reaction of pyromellitic dianhydride with a mixture of 3,3′,5,5′-tetramethyl-4,4′-methylene dianiline and 3,3′-diaminodiphenyl sulfone; poly(pyromellitic dianhydride-2,4,6-trimethyl-m-phenylenediamine-4,4′-diaminodiphenyl sulfone) polyimide derived from the polycondensation reaction of pyromellitic dianhydride with a mixture of 2,4,6-trimethyl-m-phenylenediamine and 4,4′-diaminodiphenyl sulfone; poly(pyromellitic dianhydride-3,3′,5,5′-tetramethyl-4,4′-methylene dianiline-4,4′-diaminodiphenyl sulfone) polyimide derived from the polycondensation reaction of pyromellitic dianhydride with a mixture of 3,3′,5,5′-tetramethyl-4,4′-methylene dianiline and 4,4′-diaminodiphenyl sulfone.

4. The UV cross-linkable copolyimide polymer of claim 1 that is formed into a membrane.

5. The UV cross-linkable copolyimide polymer of claim 2 that is formed into a membrane.

6. The UV cross-linkable copolyimide polymer of claim 1 further comprising a species that adsorbs strongly to a gas.

7. A high permeability UV cross-linkable copolyimide membrane comprising the UV cross-linkable copolyimide of claim 1.

8. A process for separating at least one gas from a mixture of gases comprising:
(a) providing a UV cross-linkable copolyimide polymer membrane comprising a UV cross-linkable copolyimide polymer comprising a plurality of repeating units of formula (I): 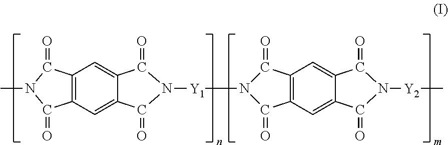
wherein Y1 is selected from the group consisting of 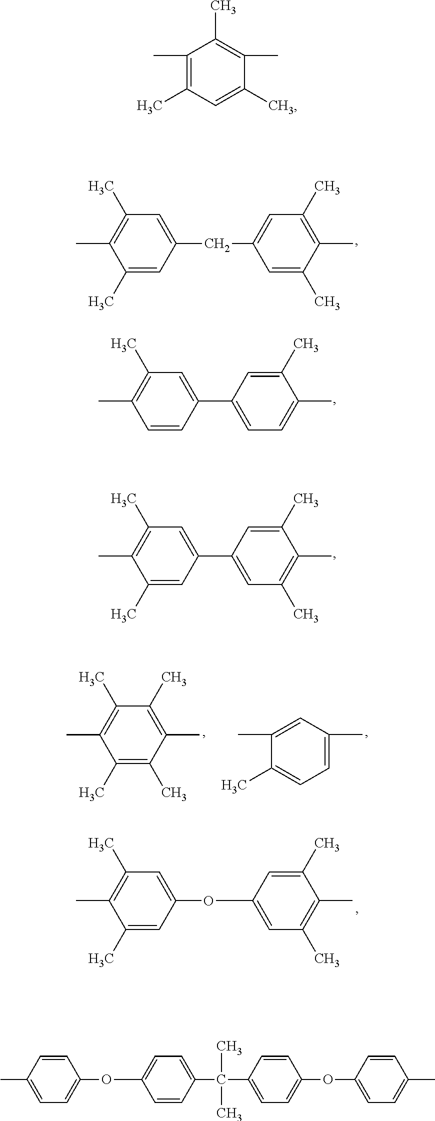
and mixtures thereof, and wherein Y2 is selected from the group consisting of 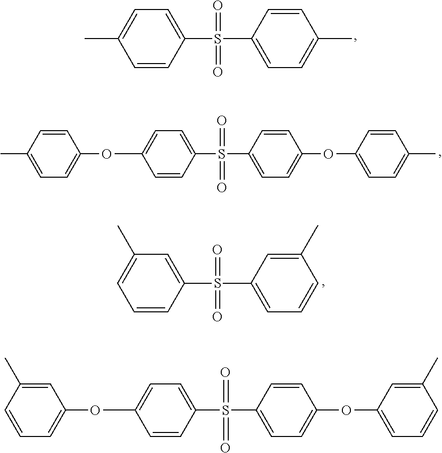
and mixtures thereof; wherein n and m are independent integers from 2 to 500;
(b) contacting the mixture of gases to one side of said UV cross-linkable copolyimide polymer membrane to cause at least one gas to permeate said membrane; and
(c) removing from an opposite side of said UV cross-linkable copolyimide polymer membrane a permeate gas composition comprising a portion of said at least one gas that permeated said membrane.

9. The process of claim 8 wherein said at least two gases are a mixture of volatile organic compounds and atmospheric gas.

10. The process of claim 8 wherein said at least two gases are a mixture of helium, carbon dioxide or hydrogen sulfide, or mixtures thereof in a natural gas stream.

11. The process of claim 8 wherein said mixture of gases are a pair of gases selected from the group consisting of nitrogen and oxygen, carbon dioxide and methane, hydrogen and methane or a mixture of carbon monoxide, helium and methane.

12. The process of claim 8 wherein said mixture of gases are selected from the group consisting of a mixture of iso and normal paraffins, and a mixture of xylenes.

13. The process of claim 8 wherein said mixture of gases are a hydrocarbon vapor and hydrogen.

14. The process of claim 8 wherein the mixture of gases comprises methane, carbon dioxide, oxygen, nitrogen, water vapor, hydrogen sulfide, and helium.

15. The process of claim 8 wherein said UV cross-linkable copolyimide polymer membrane is exposed to UV radiation to form a UV cross-linked copolyimide polymer membrane.

16. A pervaporation process for separating at least one liquid from a mixture of liquids comprising:
(a) providing a UV cross-linkable copolyimide polymer membrane comprising a UV cross-linkable copolyimide polymer comprising a plurality of repeating units of formula (I): 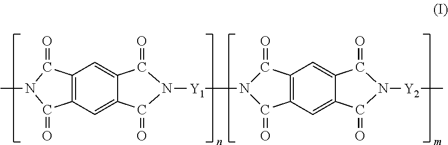
wherein Y1 is selected from the group consisting of 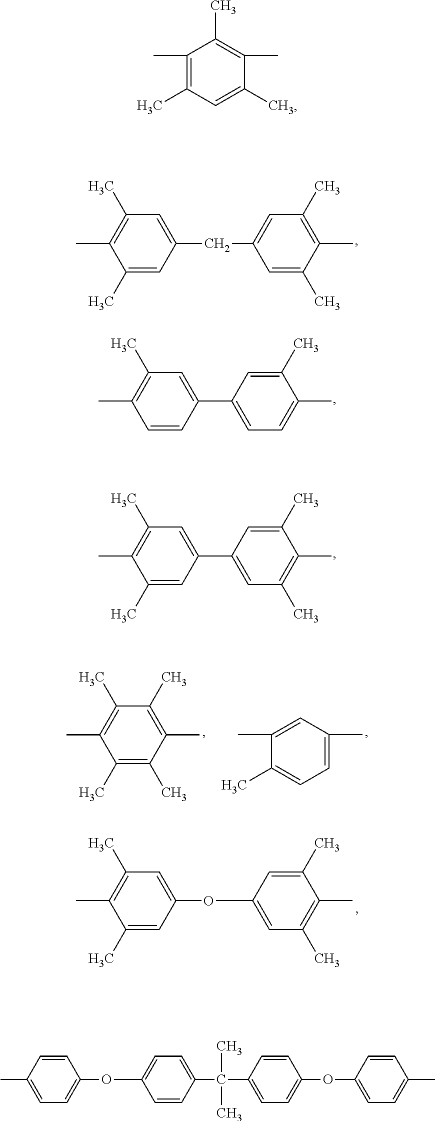
and mixtures thereof, and wherein Y2 is selected from the group consisting of 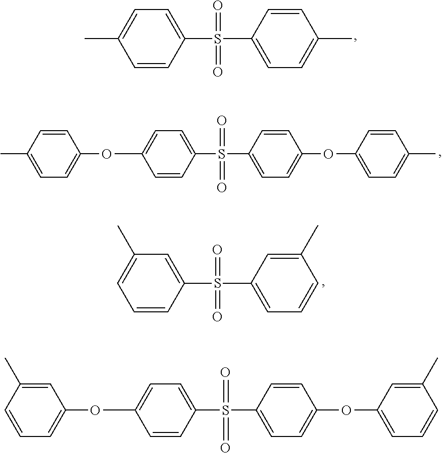
and mixtures thereof; wherein n and m are independent integers from 2 to 500;
(b) contacting the mixture of liquids to one side of said UV cross-linkable copolyimide polymer membrane to cause at least one vapor phase to permeate said membrane; and
(c) removing from an opposite side of said UV cross-linkable copolyimide polymer membranea permeate a gas composition comprising a portion of said at least one vapor phase that permeated said membrane.

17. The process of claim 16 wherein said liquid mixture comprises one or more organic compounds selected from the group consisting of alcohols, phenols, chlorinated hydrocarbons, pyridines, and ketones in water.

18. The process of claim 16 wherein said liquid mixture comprises a naphtha hydrocarbon stream comprising sulfur-containing compounds.

19. The process of claim 16 wherein said liquid mixture comprises a mixture of organic compounds selected from the group consisting of ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.
